(19) United States
(12) Patent Application Publication
(10) Pub. No.: US 2026/0054252 A1
(43) Pub. Date: Feb. 26, 2026

(54) METHOD OF MANUFACTURING POROUS SILICA SUPPORT AND CATALYST FOR DRY METHANE REFORMING REACTION

(71) Applicant: GWANGJU INSTITUTE OF SCIENCE AND TECHNOLOGY, Gwangju (KR)

(72) Inventors: Sung Bong KANG, Gwangju (KR); Haehyun MIN, Gwangju (KR); Ye Jin JI, Gwangju (KR)

(21) Appl. No.: 19/014,198

(22) Filed: Jan. 8, 2025

(30) Foreign Application Priority Data
Aug. 21, 2024 (KR) 10-2024-0111931

(51) Int. Cl. B01J 21/08; B01J 23/755; B01J 35/30; B01J 35/52; B01J 35/61; B01J 35/64; B01J 35/69; B01J 37/08; B01J 37/12

(52) U.S. Cl. CPC B01J 21/08; B01J 23/755; B01J 35/396; B01J 35/52; B01J 35/615; B01J 35/647; B01J 35/69; B01J 37/08; B01J 37/12; B01J 2235/10; B01J 2235/15; B01J 2235/30

(57) ABSTRACT

The present inventive concept relates to a method of manufacturing a porous silica support and a catalyst for a dry methane reforming reaction comprising the porous silica manufactured thereby. According to the present inventive concept, a porous silica support having a variety of controlled pore structures and silica shapes and having hydroxyl groups (—OH) formed on the surface thereof may be manufactured by controlling the mixing molar ratio of two alkoxysilanes (APTES and TEOS) used as silica precursors. In the catalyst in which an active metal is supported on the porous silica support, the active metal strongly interacts with silica through the hydroxyl groups, thereby enhancing catalytic activity, promoting dissociation/adsorption of CO₂, and alleviating carbon formation. Therefore, the catalytic activity is enhanced compared to a conventional catalyst in which an active metal is supported on silica having single mesopores and containing no hydroxyl groups in a dry methane reforming reaction.

### CLAIM FOR PRIORITY

This application claims priority to Korean Patent Application No. 2024-0111931 filed on Aug. 21, 2024 in the Korean Intellectual Property Office (KIPO), the entire contents of which are hereby incorporated by reference.

### BACKGROUND

### 1. Technical Field

Example embodiments of the present inventive concept relate to a catalyst for a dry methane reforming reaction, and more particularly, to a support for a catalyst for a dry methane reforming reaction.

### 2. Related Art

Dry reforming of methane (DRM) is a technology that produces synthesis gas, which is the basis of the chemical industry, while simultaneously reducing greenhouse gases, methane (CH₄) and carbon dioxide (CO₂). In the DRM reaction, Ni-based catalysts are known as representative active species of DRM catalysts. However, since the Tamman temperature, which is the temperature at which Ni atoms obtain sufficient energy required for bulk mobility, is low, they may be easily sintered at high temperatures (greater than 590° C.). Also, the biggest obstacle to overcome for commercializing the DRM reaction using Ni is the formation of coke, which leads to catalyst deactivation.

Meanwhile, it is known that the overall catalytic properties may be controlled by adjusting the physicochemical properties of the catalyst support. Using an appropriate support that is porous and highly stable may improve the dispersion of Ni active species and enhance the thermal stability of the catalyst.

Meanwhile, silica significantly reduces the concerns related to coke formation due to its inherent inert properties and neutrality, and its inherent cost-effectiveness as well as its excellent thermal and chemical stability improves its suitability as a catalyst support. However, the inert properties of silica indicate a weak interaction between the active metal (i.e., nickel) and silica, and therefore, it is necessary to develop a silica support that has a strong interaction with the active metal for catalytic performance and stability and has an improved CO₂ adsorption capacity.

### Related-Art Document

### Patent Document

Korean Patent No. 10-2075011

### SUMMARY

Accordingly, example embodiments of the present inventive concept are provided to substantially obviate one or more problems due to limitations and disadvantages of the related art.

Example embodiments of the present inventive concept provide a method of manufacturing a porous silica support with a controlled pore structure and shape.

Example embodiments of the present inventive concept also provide a porous silica support whose pore structure and shape are controlled by the method of manufacturing a silica support.

Example embodiments of the present inventive concept also provide a catalyst for a dry methane reforming reaction in which a metal is supported on the silica support.

In some example embodiments, a method of manufacturing a porous silica support is provided. The method of manufacturing a porous silica support is characterized by including reacting a reaction mixture consisting of water, a surfactant, aminopropyltriethoxysilane (APTES), and tetraethyl orthosilicate (TEOS) to form a silica gel (S10); and calcining the silica gel to manufacture a porous silica support (S20), wherein the pore structure and shape of the formed porous silica support are controlled by controlling the mixing molar ratio of APTES and TEOS (APTES/TEOS).

A porous silica support in the form of a hollow spherical shell may be manufactured by controlling the mixing molar ratio of APTES and TEOS (APTES/TEOS) to less than 0.1, wherein the porous silica support has an average pore diameter of 12 to 20 nm and a specific surface area of 130 to 140 m² g⁻¹ and has hydroxyl groups (—OH) formed on the surface thereof.

A porous silica support, in which solid spherical silica particles are aggregated, may be manufactured by controlling the mixing molar ratio of APTES and TEOS (APTES/TEOS) to from 0.1 to 1.0, wherein the porous silica support has a bimodal pore structure of first pores having an average pore diameter of 2 to 5 nm and second pores having an average pore diameter of 20 to 50 nm, wherein the pores are connected to each other to form a network structure, and has a specific surface area of 280 to 450 m² g⁻¹ and has hydroxyl groups (—OH) formed on the surface thereof.

A bulky porous silica support, which has an average pore diameter of less than 2 nm and a specific surface area of 340 to 460 m² g⁻¹ and has hydroxyl groups (—OH) formed on the surface thereof, may be manufactured by controlling the mixing molar ratio of APTES and TEOS (APTES/TEOS) to more than 1.0.

The surfactant may be selected from the group consisting of oleic acid, stearic acid, octanoic acid, decanoic acid, dodecanoic acid, tetradecanoic acid, hexadecanoic acid, octadecanoic acid, eicosanoic acid, docosanoic acid, cetrimonium bromide, dodecyltrimethylammonium bromide, and tetradecyltrimethylammonium bromide.

The surfactant may be included in an amount of 0.006 to 0.007 mol. % with respect to water.

The calcination may be performed at 500 to 800° C. in air.

In other example embodiments, a catalyst for a dry methane reforming reaction is provided. The catalyst for a dry methane reforming reaction includes the porous silica support manufactured by the method of manufacturing a porous silica support; and an active metal supported on the porous silica support.

The porous silica support is characterized by having a bimodal pore structure of first pores having an average pore diameter of 2 to 5 nm and second pores having an average pore diameter of 20 to 50 nm, wherein the pores are connected to each other to form a network structure, and having a specific surface area of 380 to 450 m² g⁻¹ and hydroxyl groups (—OH) formed on the surface thereof.

The active metal may be uniformly dispersed within the pores of the silica support through electrostatic interaction with the hydroxyl groups (—OH) on the surface of the silica support.

The active metal may be nickel.

The nickel may include nickel oxide (NiO), nickel hydroxide (Ni(OH)₂), and nickel oxyhydroxide (NiOOH), and the nickel oxyhydroxide (NiOOH) may have a surface atomic concentration (%) of 3 to 16%.

The nickel may include nickel oxide (NiO), nickel hydroxide (Ni(OH)₂), and nickel oxyhydroxide (NiOOH), and the sum of NiOOH and Ni(OH)₂ may account for 13 to 29% of the total nickel (Ni) phase.

The nickel is characterized by including NiO particles having a first size and disposed in the pores of the silica support and NiO particles having a second size and disposed on the surface of the silica support, wherein the first size may be smaller than the second size.

In still other example embodiments, a porous silica manufactured by the manufacturing method is provided.

The porous silica may be porous silica in the form of a hollow spherical shell, which has an average pore diameter of 12 to 20 nm and a specific surface area of 130 to 140 m² g⁻¹, and has hydroxyl group (—OH) formed on the surface thereof.

The porous silica may be porous silica in which solid spherical silica particles are aggregated, wherein the porous silica has a bimodal pore structure of first pores having an average pore diameter of 2 to 5 nm and second pores having an average pore diameter of 20 to 50 nm, wherein the pores are connected to each other to form a network structure, and has a specific surface area of 280 to 450 m² g⁻¹ and has hydroxyl groups (—OH) formed on the surface thereof.

The porous silica may be bulky porous silica which has an average pore diameter of less than 2 nm and a specific surface area of 340 to 460 m² g⁻¹, and has hydroxyl groups (—OH) formed on the surface thereof.

### BRIEF DESCRIPTION OF DRAWINGS

Example embodiments of the present inventive concept will become more apparent by describing in detail example embodiments of the present inventive concept with reference to the accompanying drawings, in which:

FIG. 1 is a flowchart showing a method of manufacturing a silica support according to one example embodiment of the present inventive concept;

FIG. 2 is a schematic diagram of a catalyst for a dry methane reforming reaction according to one example embodiment of the present inventive concept;

FIG. 3 shows X-ray diffraction patterns of the silica supports manufactured according to one example embodiment of the present inventive concept;

FIG. 4 shows transmission electron micrographs of the silica supports manufactured according to one example embodiment of the present inventive concept;

FIG. 5 is a graph showing the surface zeta potentials of the silica supports manufactured according to one example embodiment of the present inventive concept;

FIG. 6 shows surface FT-IR analysis spectra of the silica supports manufactured according to one example embodiment of the present inventive concept;

FIG. 7 shows N₂ adsorption curves for the silica supports manufactured according to one example embodiment of the present inventive concept;

FIG. 8 is a BJH plot of silica according to the amine concentration in a sol-gel reaction for the silica supports manufactured according to one example embodiment of the present inventive concept;

FIG. 9 shows XRD spectra of the catalysts manufactured according to one example embodiment of the present inventive concept;

FIGS. 10 and 11 show energy dispersive X-ray spectroscopy (EDS) elemental analysis spectra of the catalysts manufactured according to one example embodiment of the present inventive concept;

FIG. 12 is a transmission electron microscope (TEM) image of the catalysts manufactured according to one example embodiment of the present inventive concept and a comparative example;

FIG. 13 shows the size distribution of nickel particles formed on the catalysts manufactured according to one example embodiment of the present inventive concept and a comparative example;

FIG. 14 shows N₂ adsorption curves for the catalysts manufactured according to one example embodiment of the present inventive concept and a comparative example;

FIG. 15 is a BJH plot according to the amine concentration of the catalysts manufactured according to one example embodiment of the present inventive concept and a comparative example

FIG. 16 shows surface IR profiles of the catalysts manufactured according to one example embodiment of the present inventive concept and a comparative example;

FIG. 17 is a Ni 2p XPS graph of the catalysts manufactured according to one example embodiment of the present inventive concept and a comparative example;

FIG. 18 is a graph showing the H₂-temperature-programmed reduction analysis of the catalysts manufactured according to one example embodiment of the present inventive concept and a comparative example;

FIG. 19 is a CO₂-temperature-programmed desorption (CO₂-TPD) analysis graph of the catalysts manufactured according to one example embodiment of the present inventive concept and a comparative example;

FIG. 20 is an NH₃-temperature-programmed desorption (NH₃-TPD) analysis graph of the catalysts manufactured according to one example embodiment of the present inventive concept and a comparative example;

FIG. 21 is a graph showing the temperature-dependent activity of CH₄ conversion during dry reforming of methane (DRM) of the catalysts manufactured according to one example embodiment of the present inventive concept and a comparative example;

FIG. 22 is a graph showing the temperature-dependent activity of CO₂ conversion during dry reforming of methane (DRM) of the catalysts manufactured according to one example embodiment of the present inventive concept and a comparative example;

FIG. 23 is a graph showing the product ratios (H₂/CO) during dry reforming of methane (DRM) of the catalysts manufactured according to one example embodiment of the present inventive concept and a comparative example; and

FIG. 24 is a graph showing the catalytic activity during dry reforming of methane (DRM) of the catalysts manufactured according to one example embodiment of the present inventive concept and a comparative example.

### DESCRIPTION OF EXAMPLE EMBODIMENTS

Example embodiments of the present inventive concept are disclosed herein. However, specific structural and functional details disclosed herein are merely representative for purposes of describing example embodiments of the present inventive concept, however, example embodiments of the present inventive concept may be embodied in many alternate forms and the present inventive concept should not be construed as limited to example embodiments set forth herein.

Accordingly, since the present inventive concept is susceptible to various modifications and alternative forms, specific embodiments thereof are shown by way of example in the drawings and will herein be described in detail. It should be understood, however, that there is no intent to limit the inventive concept to the particular forms disclosed, but on the contrary, the inventive concept is to cover all modifications, equivalents, and alternatives falling within the spirit and scope of the inventive concept. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be named a second element, and, similarly, a second element could be named a first element, without departing from the scope of the present inventive concept. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the inventive concept. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/actions noted in the blocks may occur out of the order noted in the flowcharts. For example, two blocks shown in succession may in fact be executed substantially concurrently or the blocks may sometimes be executed in the reverse order, depending upon the functions/actions involved.

### [Method of Manufacturing Porous Silica Support]

One aspect of the present inventive concept provides a method of manufacturing a porous silica support.

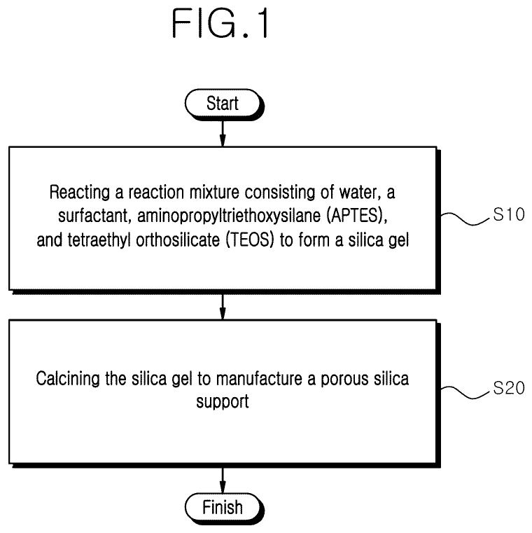

FIG. 1 is a flowchart showing a method of manufacturing a silica support according to one example embodiment of the present inventive concept.

Referring to FIG. 1, the method of manufacturing a silica support includes:
reacting a reaction mixture consisting of water, a surfactant, aminopropyltriethoxysilane (APTES), and tetraethyl orthosilicate (TEOS) to form a silica gel (S10); and calcining the silica gel to manufacture a porous silica support (S20).

First, Step S10 includes forming a silica gel by subjecting the reaction mixture to a sol-gel reaction.

The reaction mixture consists of water, a surfactant, aminopropyltriethoxysilane (APTES), and tetraethyl orthosilicate (TEOS).

In this case, the mixing molar ratio of APTES and TEOS as silica precursors is a very important factor that affects the silica morphology, pore structure, and surface properties.

Specifically, in a microemulsion system including water and a surfactant, the amphiphilic APTES present at the oil-water interface is hydrolyzed to generate APTES-H⁺ (APTES+H₂O→APTES-H⁺+OH⁻). The generated OH-ion initiates a nucleophilic attack on Si, the most electropositive atom of TEOS, thereby initiating the hydrolysis of TEOS(≡Si-OEt+OH⁻→≡Si—O—Si≡+EtOH, where Et is an ethyl group). At the oil-water interface, the two hydrolyzed alkoxysilanes, i.e., protonated APTES and deprotonated TEOS, aggregate by electrostatic attraction and condensation to form a silica gel.

However, when the percentage of TEOS in the mixing molar ratio of APTES and TEOS is high (APTES/TEOS molar ratio of less than 1.0), the hydrophobic TEOS behavior is dominant. Therefore, a hydrolysis-condensation reaction mainly occurs in the oil droplets of the oil-in-water emulsion to form spherical silica, which grows into aggregated spheres of silica gel due to the electrical interaction between the protonated APTES and the deprotonated TEOS. On the other hand, as the percentage of APTES increases, the particle size of the spherical silica decreases, resulting in particle aggregation. When the concentration of APTES is the same as or greater than that of TEOS (APTES/TEOS molar ratio of 1.0 or more), the silica gel grows into a shapeless homogeneous bulky form through the diffusion of protonated APTES into the continuous phase under hydrolysis.

Specifically, when the mixing molar ratio of APTES and TEOS (APTES/TEOS) is controlled to less than 0.1, a porous silica support having a hollow spherical shell shape is formed. On the other hand, when the mixing molar ratio of APTES and TEOS (APTES/TEOS) is controlled to 0.1 or more and 1.0 or less, the solid spherical silica is aggregated to form a porous silica support having a bimodal pore structure of first pores and second pores, and when the mixing molar ratio of APTES and TEOS (APTES/TEOS) is controlled to more than 1.0, a bulky porous silica support is formed.

That is, it can be seen that the APTES/TEOS mixing molar ratio is important in determining the silica morphology.

Also, as the APTES/TEOS mixing molar ratio increases, the pH of the silica gel solution after the sol-gel reaction increases from 7.1 to 9.6, the zeta potential further decreases from −24.22 to −3.26, and the distribution of protonated amines (NH₃⁺) on the surface of gel increases during the reaction of silica precursors. In other words, it can be seen that the APTES/TEOS molar ratio also affects the surface morphology of silica. These protonated amines are removed by oxidation during the calcination step, and hydroxyl groups are generated in the removed sites.

The surfactant acts to disperse the hydrophobic TEOS as a silica precursor so that it can react in water, and also acts as a catalyst for the condensation polymerization reaction of silica precursors while influencing the silica morphology. The surfactant may be selected from the group consisting of oleic acid, stearic acid, octanoic acid, decanoic acid, dodecanoic acid, tetradecanoic acid, hexadecanoic acid, octadecanoic acid, eicosanoic acid, docosanoic acid, cetrimonium bromide, dodecyltrimethylammonium bromide, and tetradecyltrimethylammonium bromide, but the present inventive concept is not limited thereto. In this example embodiment, oleic acid is used as the surfactant.

The surfactant is preferably included in an amount of 0.006 to 0.007 mol % relative to water. When the amount of surfactant is outside the above range, there is a problem that the silica condensation reaction does not proceed when it is used in an insufficient amount, and the silica shape may not be controlled into a specific form when it is used in an excessive amount.

The generated silica gel may be dried at 75 to 90° C.

Next, Step S20 includes calcining the silica gel to form a porous silica support.

The synthesized silica gel may form mesoporous silica having a mesopore distribution through a calcination process. In this case, the calcination is preferably performed at 500 to 800° C. in air. When the calcination temperature is lower than 500° C., there is a problem that the formed silica is physically unstable. On the other hand, when the calcination temperature is higher than 800° C., there is a problem that the pores disappear, which makes it impossible to achieve porosity.

During the calcination process, protonated amines (NH₃⁺) on the surface of gel are removed by oxidation, and hydroxyl groups are generated in the removed sites, forming a large number of hydroxyl groups, i.e., silanol (Si—OH) groups, on the surface of silica.

In the case of the porous silica support that has undergone the calcination process, porous silica supports having various pore structures and shapes are formed depending on the APTES/TEOS mixing molar ratio in Step S10 as described above.

Specifically, a porous silica support in the form of a hollow spherical shell may be manufactured as the porous silica support by controlling the mixing molar ratio of APTES and TEOS (APTES/TEOS) to less than 0.1, wherein the porous silica support has an average pore diameter of 12 to 20 nm and a specific surface area of 130 to 140 m² g⁻¹, and has hydroxyl groups (—OH) formed on the surface thereof. Also, a porous silica support may be manufactured by controlling the mixing molar ratio of APTES and TEOS (APTES/TEOS) to 0.1 or more and 1.0 or less, wherein the porous silica support has a bimodal pore structure of first pores having an average pore diameter of 2 to 5 nm and second pores having an average pore diameter of 20 to 50 nm, wherein the pores are connected to each other to form a network structure, and has a specific surface area of 280 to 450 m² g⁻¹ and has hydroxyl groups (—OH) formed on the surface thereof. In addition, a bulky porous silica support, which has an average pore diameter of less than 2 nm and a specific surface area of 340 to 460 m² g⁻¹ and has hydroxyl groups (—OH) formed on the surface thereof, may be manufactured by controlling the mixing molar ratio of APTES and TEOS (APTES/TEOS) to more than 1.0.

In particular, a silica support having a bimodal pore structure may improve catalytic efficiency by facilitating the access of reactants to active sites through larger mesopores because the silica support has an increased surface area and pore volume compared to the unimodal pore structure, and the hydroxyl groups formed on the surface of silica may lower the zeta potential and enhance the binding affinity with nickel, which is an active metal, thereby maximizing nickel dispersion and improving catalytic performance.

### [Catalyst for Dry Methane Reforming Reaction]

Another aspect of the present inventive concept provides a catalyst for a dry methane reforming reaction including the silica support.

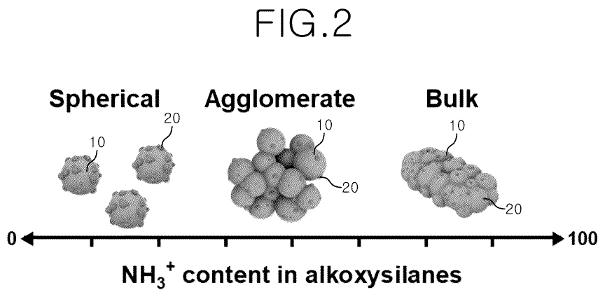

FIG. 2 is a schematic diagram of a catalyst for a dry methane reforming reaction according to one example embodiment of the present inventive concept.

Referring to FIG. 2, the catalyst includes a silica support 10 and an active metal 20 supported on the silica support.

The silica support 10 is as described above, and thus a detailed description thereof is omitted to avoid redundant description.

The active metal may be uniformly dispersed within the pores of the silica support through electrostatic interaction with the hydroxyl groups (—OH) on the surface of the silica support. The active metal may be any metal, including a noble metal or a non-noble metal, as long as it exhibits catalytic activity. In this case, nickel may be preferably used.

The nickel may be present in various species when supported on the silica support, and specifically includes nickel oxide (NiO), nickel hydroxide (Ni(OH)₂), and nickel oxyhydroxide (NiOOH).

In this case, the contents of various species of nickel vary depending on the mixing molar ratio of APTES and TEOS used to manufacture the silica support. In this case, the ratio of NiOOH and Ni(OH)₂ supports that hydroxyl groups induce and enhance the interaction between nickel and silica, and the surface atomic concentration (%) of nickel oxyhydroxide (NiOOH) may be 3 to 16%, and the sum of NiOOH and Ni(OH)₂ may account for 13 to 29% of the total Ni phase. In particular, when the molar ratio of APTES and TEOS (APTES/TEOS) is adjusted to 0.5 or more and 1 or less, the surface atomic concentration (%) of nickel oxyhydroxide (NiOOH) may be a high ratio of 13 to 16%, and the sum of NiOOH and Ni(OH)₂ accounts for 25 to 29% of the total Ni phase. Thus, the silica support may have a higher ratio of hydroxyl groups compared to other molar ratios. When the APTES/TEOS ratio is greater than 1, the availability of OH groups capable of interacting with Ni decreases due to the collapse of the porous structure of the silica support when reacting with nickel, so that the sum of NiOOH and Ni(OH)₂ appears somewhat low.

Also, the silica support having an APTES/TEOS ratio of 0.1 or more and 0.5 or less showed a partial structural change from a bimodal pore structure to a unimodal pore structure after nickel impregnation. However, the silica support having an intermediate APTES/TEOS ratio (0.5≤APTES/TEOS≤1) maintained its bimodal pore structure even after nickel impregnation. The nickel is characterized in that it includes NiO particles having a first size and disposed in the pores of the silica support and NiO particles having a second size and disposed on the surface of the silica support, wherein the first size is smaller than the second size. For example, in the catalyst according to the present inventive concept, the Ni supported on silica includes NiO particles having two sizes, that is, a smaller one (approximately 14 nm) in the mesopore structure and a larger one (greater than 40 nm) on the surface of silica.

Still another aspect of the present inventive concept provides a method of manufacturing the catalyst for a dry methane reforming reaction.

The method of manufacturing a catalyst may use an impregnation method, and specifically includes adding an aqueous solution of an active metal precursor salt to a silica dispersion in which the porous silica support is dispersed in water, mixing the aqueous solution and the silica dispersion, and then calcining the resulting mixture to produce a silica catalyst on which an active metal is supported.

At this time, a known metal precursor salt may be used as the active metal precursor salt. For example, a nickel salt, specifically nickel nitrate, may be used, but the present inventive concept is not limited thereto.

The active metal precursor salt is preferably added in an amount of 0.1 to 20% by weight relative to the silica dispersion. In this case, when the amount of the active metal precursor salt is outside the above range, there is a problem of reducing catalyst efficiency.

The calcination is preferably performed at 500 to 800° C. When the calcination temperature is too low, the silica support may be physically unstable. On the other hand, when the calcination temperature is too high, all pores may disappear.

According to the present inventive concept, as the silica support manufactured by controlling the ratio of two alkoxysilanes, TEOS and APTES, used as silica precursors, 1) when the ratio of TEOS and APTES is controlled to less than 0.1, a porous silica support in the form of a hollow spherical shell is formed, wherein the porous silica support has an average pore diameter of 12 to 20 nm and a specific surface area of 130 to 140 m² g⁻¹ at the oil-water interface of a microemulsion, and has hydroxyl groups (—OH) formed on the surface thereof; 2) when the ratio of TEOS and APTES is controlled to 0.1 or more and 1.0 or less, a porous silica support in which solid spherical silica particles are aggregated is formed, wherein the porous silica support has a bimodal pore structure of first pores having an average pore diameter of 2 to 5 nm and second pores having an average pore diameter of 20 to 50 nm, wherein the pores are connected to each other to form a network structure, and has a specific surface area of 280 to 450 m² g⁻¹ and has hydroxyl groups (—OH) formed on the surface thereof; and 3) when the ratio of TEOS and APTES is controlled to more than 1.0, a bulky porous silica support is formed, wherein the bulky porous silica support has an average pore diameter of less than 2 nm and a specific surface area of 340 to 460 m² g⁻¹, and has hydroxyl groups (—OH) formed on the surface thereof, thereby confirming that the pore structure and silica morphology may be controlled depending on the mixing ratio of TEOS and APTES.

In particular, when the ratio of TEOS and APTES is controlled to be 0.5 or more and 1.0 or less, the silica support exhibits a bimodal pore structure even during the manufacture of the catalyst, and hydroxyl groups are formed on the surface of the support. As a result, when nickel is supported as an active metal, nickel interacts strongly with silica through the hydroxyl groups on the surface of silica in the form of various nickel oxides, thereby enhancing catalytic activity, promoting dissociation/adsorption of CO₂, and alleviating carbon formation. Therefore, when nickel is used as a catalyst in a dry methane reforming reaction, it shows an initial CO₂ conversion rate of 94% and a CO₂ conversion rate of 90% or more even after 12 hours, indicating excellent catalytic activity. Therefore, nickel may be usefully used as a catalyst for a dry methane reforming reaction.

Hereinafter, preferred preparation examples and experimental examples are presented to help understand the present inventive concept. However, it should be understood that the following preparation examples and experimental examples are only provided to help understand the present inventive concept, and are not intended to limit the present inventive concept.

### Preparation Example 1: Manufacture of Silica Support

As silica precursors, aminopropyltriethoxysilane (APTES) and tetraethyl orthosilicate (TEOS) were mixed in a molar ratio of 5:95 (APTES:TEOS), added to deionized water (D.I. water; 57 mL) in which oleic acid (2 mmol) was dispersed, and reacted for 12 hours at 80° C. while vigorously stirring to produce a silica gel, which was then dried at 80° C. and calcined in air at 800° C. (1° C./min) for 2 hours to manufacture a silica support.

### Preparation Example 2

A silica support was manufactured in the same manner as Preparation Example 1, except that the APTES and TEOS used in Preparation Example 1 were mixed at a molar ratio of 15:85.

### Preparation Example 3

A silica support was manufactured in the same manner as Preparation Example 1, except that the APTES and TEOS used in Preparation Example 1 were mixed at a molar ratio of 25:75.

### Preparation Example 4

A silica support was manufactured in the same manner as Preparation Example 1, except that the APTES and TEOS used in Preparation Example 1 were mixed at a molar ratio of 35:65.

### Preparation Example 5

A silica support was manufactured in the same manner as Preparation Example 1, except that the APTES and TEOS used in Preparation Example 1 were mixed at a molar ratio of 50:50.

### Preparation Example 6

A silica support was manufactured in the same manner as Preparation Example 1, except that the APTES and TEOS used in Preparation Example 1 were mixed at a molar ratio of 65:35.

### Preparation Example 7

A silica support was manufactured in the same manner as Preparation Example 1, except that the APTES and TEOS used in Preparation Example 1 were mixed at a molar ratio of 85:15.

### Comparative Example 1

Commercially available silica (Ni/com-SiO₂) was used.

Hereinafter, the ratios of silica precursors in the manufacture of a silica support are summarized in Table 1 below.

TABLE 1

| | APTES:TEOS | APTES | TEOS | |
|---|---|---|---|---|
| Classification | molar ratio | [mmol] | [mmol] | APTES/TEOS |
| Preparation | 5:95 | 2.2 | 40.8 | 0.05 |
| Example 1 | | | | |
| Preparation | 15:85 | 6.1 | 35.3 | 0.17 |
| Example 2 | | | | |
| Preparation | 25:75 | 11.2 | 33.3 | 0.34 |
| Example 3 | | | | |
| Preparation | 35:65 | 14.5 | 26.9 | 0.54 |
| Example 4 | | | | |
| Preparation | 50:50 | 20.9 | 20.6 | 1.0 |
| Example 5 | | | | |
| Preparation | 65:35 | 27.1 | 14.5 | 1.87 |
| Example 6 | | | | |
| Preparation | 85:15 | 35.4 | 6.2 | 5.71 |
| Example 7 | | | | |

### Experimental Example 1: Measurement of Changes in Crystal Structure and Particle Morphology According to APTES:TEOS Molar Ratio During Manufacture of Silica Support

X-ray diffraction (XRD) pattern and transmission electron microscope (TEM) analysis were performed to determine the crystal structure and composition of the manufactured silica support.

Specifically, for the silica supports manufactured according to Preparation Examples 1 to 7, X-ray diffraction patterns were obtained at a scan rate of 8° min⁻¹ over 2θ in the range of 10° to 80° at an acceleration voltage of 40 k and a current of 30 mA using a high-resolution X-ray diffractometer (SmartLab, Rigaku) equipped with a Cu target Kα X-ray source, and transmission electron micrographs were obtained using a high-resolution dual Cs-corrected transmission electron microscope (HR-STEM).

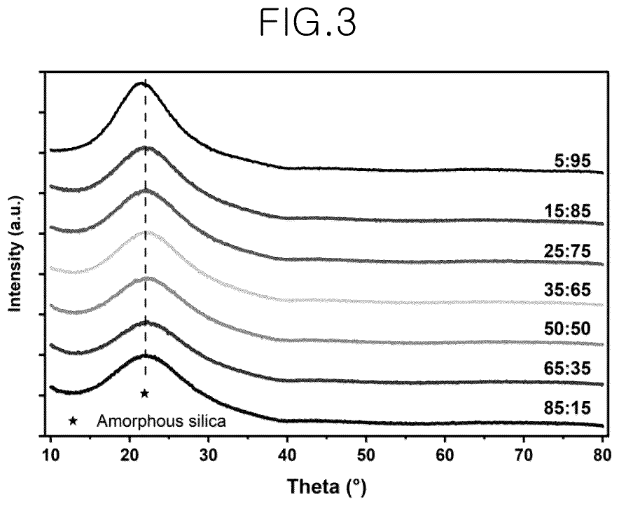

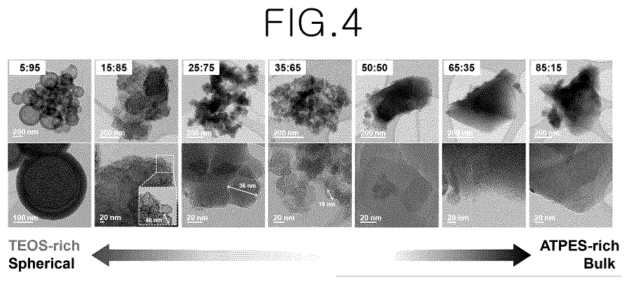

The results are shown in FIGS. 3 and 4.

FIG. 3 shows X-ray diffraction patterns of silica supports manufactured according to Preparation Examples 1 to 7 of the present inventive concept.

As shown in FIG. 3, it was confirmed that the synthesized silica maintained a consistent amorphous silica SiO₂ phase in all test samples regardless of the APTES:TEOS molar ratio.

FIG. 4 shows transmission electron micrographs of the silica supports manufactured according to Preparation Examples 1 to 7 of the present inventive concept.

As shown in FIG. 4, spherical silica was formed under TEOS-rich conditions, i.e., when the APTES/TEOS molar ratio was less than 1.0. As the APTES/TEOS molar ratio increased from approximately 0.05 to approximately 0.54, the particle size of the spherical silica decreased from approximately 350 nm to approximately 20 nm, resulting in particle aggregation. On the other hand, when the concentration of APTES was the same as or greater than that of TEOS, the silica grew in bulk while exhibiting a homogeneous phase. In particular, the silica (Preparation Example 1) manufactured by mixing APTES and TEOS at a molar ratio of 5:95 through a microemulsion method was observed to have a hollow shell shape, suggesting that the condensation reaction was completed at the oil-water interface, unlike the other samples (Preparation Examples 2 to 7). The observation of this unique hollow shell-type silica suggests that the molar ratio of the two agents, i.e., APTES and TEOS, is important in determining the silica morphology.

### Experimental Example 2: Confirmation of Hydroxyl Groups (OH) on Surface of Silica Support

To confirm that hydroxyl groups are formed on the surface of the silica support manufactured according to the present inventive concept, the zeta potential of the silica particles was measured, and FT-IR spectroscopy was performed.

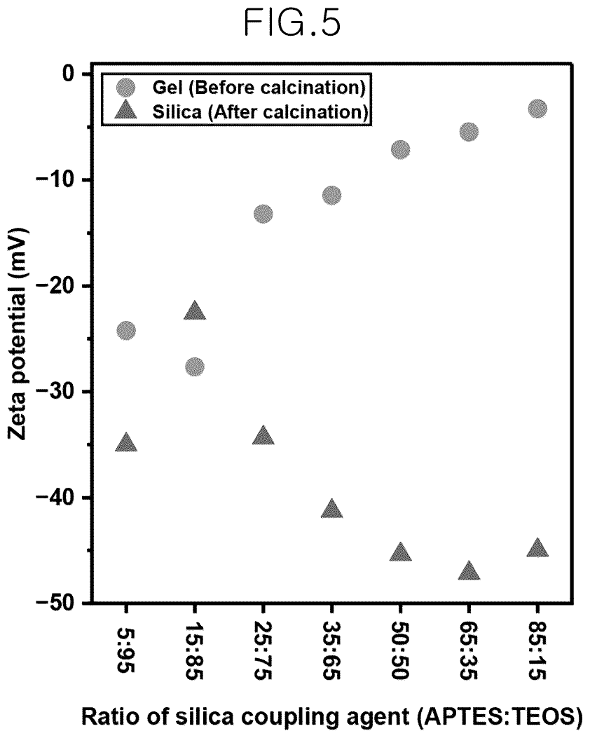

Specifically, the zeta potentials of the silica supports manufactured according to Preparation Examples 1 to 7 before and after calcination were measured using a measuring device (Solid Surface Zeta 129 Potential Measurement System, Photal OTSUKA Electronics). Before measurement, the silica gel synthesized by the sol-gel reaction was dispersed in deionized water (20 mL), and then sonicated for 10 minutes. Thereafter, the pH of the solution was measured and shown in Table 2 below, and the surface zeta potential according to the pH was measured and shown in FIG. 5.

TABLE 2

| | APTES:TEOS molar | pH of silica gel before |
|---|---|---|
| Classification | ratio (APTES/TEOS) | calcination |
| Preparation | 5:95 | 7.1 |
| Example 1 | (0.05) | |
| Preparation | 15:85 | 8.2 |
| Example 2 | (0.17) | |
| Preparation | 25:75 | 9.0 |
| Example 3 | (0.34) | |
| Preparation | 35:65 | 9.2 |
| Example 4 | (0.54) | |
| Preparation | 50:50 | 9.3 |
| Example 5 | (1.0) | |
| Preparation | 65:35 | 9.4 |
| Example 6 | (1.87) | |
| Preparation | 85:15 | 9.6 |
| Example 7 | (5.71) | |

FIG. 5 is a graph showing the surface zeta potentials of the silica supports manufactured according to Preparation Examples 1 to 7 of the present inventive concept

As shown in Table 2, as the APTES/TEOS ratio before calcination increased, the pH of the solution after the sol-gel reaction increased from 7.1 to 9.6, and the zeta potential changed from −24.22 to −3.26, as shown in FIG. 5. This trend is due to the protonated APTES (APTES+H⁺→APTES-H⁺) generated by hydrolysis during the reaction of silica precursors and the protonated amines (NH₃⁺) distributed on the gel surface. Thereafter, when calcined at 800° C. in air, it was confirmed that the ammonium ion was oxidized to leave Si—OH bonds on the surface, and the zeta potential further increased in a negative direction in the case of APTES-rich silica (APTES/TEOS≥1).

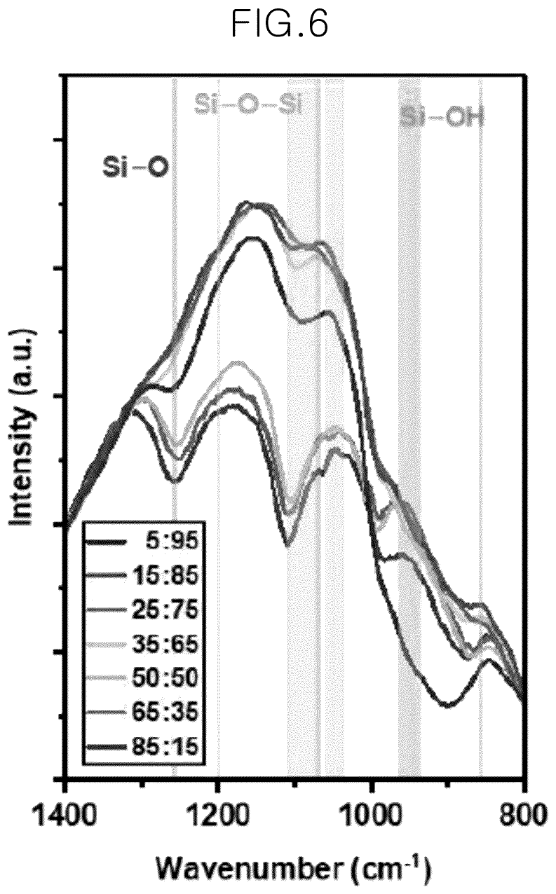

Also, surface IR analysis of the silica supports manufactured according to Preparation Examples 1 to 7 was performed using a NICOLET IS50 FT-IR (Thermo Fisher Scientific) equipped with an MCT detector. The FT-IR spectra were obtained in a frequency range of 500 to 4000 cm⁻¹ at 35° C. under a pure N₂ flow, and the reference spectrum was collected using KBr. The measurement results are shown in FIG. 6.

FIG. 6 shows surface FT-IR analysis spectra of the silica supports manufactured according to Preparation Examples 1 to 7 of the present inventive concept.

As shown in FIG. 6, the APTES-rich (APTES/TEOS≥1) silica showed the presence of silanol on the surface of silica by forming silanol (Si—OH) peaks on the surface of silica between the frequency ranges of 800 to 900 cm⁻¹ and 936 to 961 cm⁻¹. This is thought to be due to the protonated amines (NH₃⁺) distributed on the gel surface.

Also, the TEOS-rich (APTES/TEOS<1) silica exhibited stronger bands assigned to Si—O—Si at positions of 1038 to 1058 cm⁻¹, 1104 to 1070 cm⁻¹, and 1200 cm⁻¹, suggesting the complete condensation of TEOS and APTES.

Therefore, it was confirmed that the surface properties of the manufactured silica support vary depending on the APTES:TEOS molar ratio used when a silica support was manufactured, and that the silica support according to the present inventive concept had a large number of hydroxyl groups, i.e., silanol (Si—OH) groups, formed on the surface of silica by controlling the APTES:TEOS molar ratio.

### Experimental Example 3: Measurement of Pore Properties of Silica Support

To determine the pore properties of the silica support manufactured according to the present inventive concept, experiments were conducted as follows.

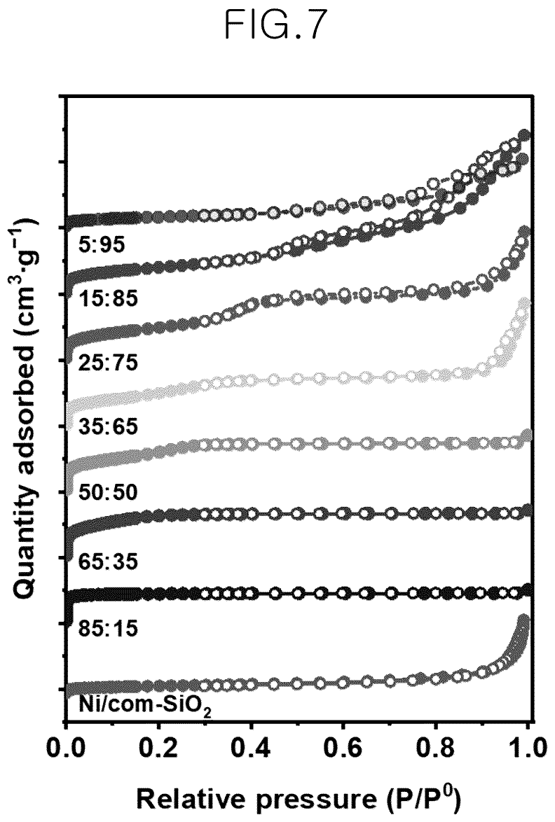

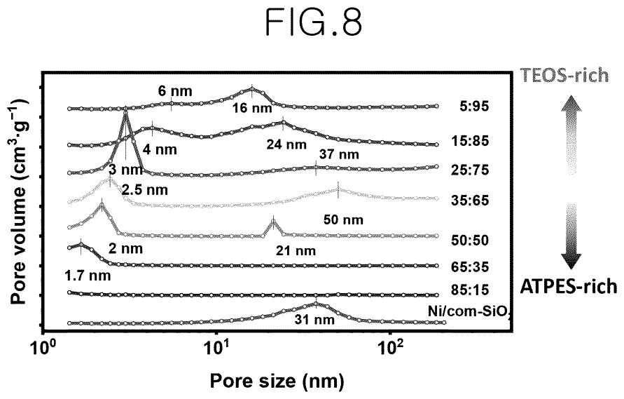

Specifically, the surface areas of the silica supports manufactured according to Preparation Examples 1 to 7 and the commercial silica support of Comparative Example 1 were measured using N₂ physical adsorption at −196° C. by a Micromeritics ASAP 2020 (MicrotacBEL Corp.) analyzer. The results are shown in FIG. 7. The specific surface areas and average pore diameters were calculated by the Brunauer-Emmett-Teller (BET) method, and the results are shown in Table 3 below, and the pore volumes were measured by the Barrett-Joyner-Halenda (BJH) method, and the results are shown in FIG. 8.

TABLE 3

| | APTES:TEOS | Specific | Average |
|---|---|---|---|
| | molar ratio | surface area | pore diameter |
| Classification | (APTES/TEOS) | [m²g⁻¹] | [nm] |
| Preparation | 5:95 (0.05) | 135.3 | 13.4 |
| Example 1 | | | |
| Preparation | 15:85 (0.17) | 288.8 | 10.3 |
| Example 2 | | | |
| Preparation | 25:75 (0.34) | 361.6 | 6.4 |
| Example 3 | | | |
| Preparation | 35:65 (0.54) | 391.4 | 5.7 |
| Example 4 | | | |
| Preparation | 50:50 (1.0) | 447.8 | 2.2 |
| Example 5 | | | |
| Preparation | 65:35 (1.87) | 453.3 | 1.9 |
| Example 6 | | | |
| Preparation | 85:15 (5.71) | 342.9 | 1.7 |
| Example 7 | | | |
| Comparative | | 218.1 | 17.4 |
| Example 1 (before | | | |
| Ni impregnation | | | |
| of Ni/com-SiO₂) | | | |

FIG. 7 shows N₂ adsorption curves for the silica supports manufactured according to Preparation Examples 1 to 7 and the commercial silica support of Comparative Example 1, and FIG. 8 is a BJH plot of silica according to the amine concentration in a sol-gel reaction for the silica supports manufactured according to Preparation Examples 1 to 7 and the commercial silica support of Comparative Example 1.

As shown in Table 3 and FIG. 8, the porous structures of the manufactured silica supports exhibited characteristic shapes depending on the concentration of amine groups.

Specifically, the silica supports having an APTES/TEOS ratio of greater than 1 exhibited a type I isotherm with a circular shape at high pressure, indicating a microporous structure having a uniform pore size of approximately 2 nm, which is consistent with the TEM analysis, whereas the silica supports having an APTES/TEOS ratio of less than 1 exhibited a type IV isotherm, which is typical of a mesoporous structure.

However, it is particularly noteworthy that a bimodal porous structure of the silica support with a microporous structure and a mesoporous structure was formed at an intermediate concentration of APTES, i.e., an APTES/TEOS ratio of 0.5 to 1.

The bimodal porous structure arises from two different formation mechanisms: the first mesopore is formed by controlling the general hydrolysis and condensation of a silica precursor. The aggregation of these spherical particles leads to the formation of larger mesopores, which contributes to the larger mesopore size. This bimodal porous structure may enhance the catalytic efficiency by facilitating the access of reactants to the active sites through the larger mesopores due to the increased surface area and pore volume compared to the unimodal porous structure.

The bimodal porous structure of the silica support is due to the behavior of amine groups in the sol-gel reaction. Specifically, in the microemulsion system, the amphiphilic APTES precursor present at the oil-water interface is hydrolyzed to generate APTES-H⁺ (APTES+H₂O→APTES-H⁺+OH⁻). The generated OH-ion initiates a nucleophilic attack on Si, the most electropositive atom of TEOS, thereby initiating the hydrolysis of TEOS(≡Si-OEt+OH⁻→≡Si—O—Si≡+EtOH, where Et is an ethyl group). At the oil-water interface, the two hydrolyzed alkoxysilanes, i.e., protonated APTES and deprotonated TEOS, aggregate by electrostatic attraction and condensation to form aggregates.

In the TEOS-rich silica, the hydrophobic TEOS behavior dominates so that the hydrolysis-condensation reaction mainly occurs in oil droplets (oil-in-water emulsions) to form spherical silica, which grows into aggregated spheres due to the electrical interaction between the protonated APTES and deprotonated TEOS. A more limited ratio of APTES concentration (5:95) completes the condensation reaction at the oil-water interface to form a shell. In contrast, the APTES-rich silica grows in a bulk form through the diffusion of protonated APTES into the continuous phase under hydrolysis.

In the silica supports, a higher concentration of APTES is advantageous in achieving a lower zeta potential, which enhances the binding affinity with nickel. However, a lower concentration of APTES is advantageous in developing a bimodal pore structure with an increased surface area and pore volume. This paradox suggests that nickel dispersion is maximized and catalytic performance is enhanced at the optimal APTES:TEOS ratio.

### Preparation Example 8: Manufacture of Catalyst on which Nickel is Supported

A Ni-impregnated silica catalyst including 5% by weight of nickel was manufactured using a conventional wet impregnation method. Specifically, a certain amount of the silica manufactured in Preparation Example 1 was dispersed in 50 mL of deionized water to prepare a silica dispersion. Next, a Ni(NO₃)₂·6H₂O solution (50 mL) was added to the silica dispersion, and mixed. After mixing, the sample was stirred vigorously, dried at 80° C., and calcined at 800° C. for 2 hours in a muffle furnace to manufacture a nickel-supported silica catalyst.

### Preparation Example 9

A nickel-supported silica catalyst was manufactured in the same manner as in Preparation Example 8, except that the silica manufactured in Preparation Example 2 was used instead of the silica of Preparation Example 1.

### Preparation Example 10

A nickel-supported silica catalyst was manufactured in the same manner as in Preparation Example 8, except that the silica manufactured in Preparation Example 3 was used instead of the silica of Preparation Example 1.

### Preparation Example 11

A nickel-supported silica catalyst was manufactured in the same manner as in Preparation Example 8, except that the silica manufactured in Preparation Example 4 was used instead of the silica of Preparation Example 1.

### Preparation Example 12

A nickel-supported silica catalyst was manufactured in the same manner as in Preparation Example 8, except that the silica manufactured in Preparation Example 5 was used instead of the silica of Preparation Example 1.

### Preparation Example 13

A nickel-supported silica catalyst was manufactured in the same manner as in Preparation Example 8, except that the silica manufactured in Preparation Example 6 was used instead of the silica of Preparation Example 1.

### Preparation Example 14

A nickel-supported silica catalyst was manufactured in the same manner as in Preparation Example 8, except that the silica manufactured in Preparation Example 7 was used instead of the silica of Preparation Example 1.

### Comparative Example 2

A commercially available nickel/silica composite catalyst (Ni/com-SiO₂) was used.

### Experimental Example 4: Measurement of Physicochemical Properties of Nickel-Supported Silica Catalysts

X-ray diffraction (XRD) analysis was performed to confirm the crystal structures and compositions of the manufactured catalysts.

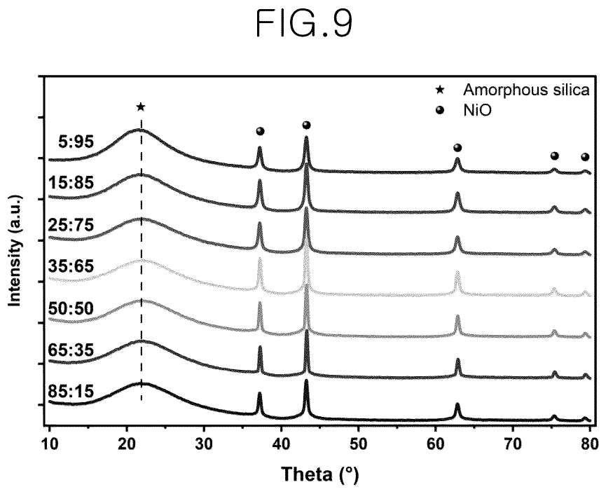

Specifically, for the catalysts manufactured according to Preparation Examples 8 to 14, X-ray diffraction patterns were obtained at a scan rate of 8° min⁻¹ over 2θ in the range of 10° to 80° at an acceleration voltage of 40 k and a current of 30 mA using a high-resolution X-ray diffractometer (SmartLab, Rigaku) equipped with a Cu target Kα X-ray source. The results are shown in FIG. 9.

FIG. 9 shows XRD spectra of the catalysts manufactured according to Preparation Examples 8 to 14 of the present inventive concept.

As shown in FIG. 9, characteristic nickel oxide (NiO) peaks appeared in the silica after nickel was impregnated on the silica support. Specifically, the peaks at 2θ of 37.25°, 43.28°, 65.86°, 75.39°, and 79.39° may be assigned to the NiO crystal planes of (111), (200), (220), (311), and (222), respectively. Also, the broad peak at 2θ of 21° is a signal of amorphous SiO₂. Therefore, it was confirmed that nickel oxide was formed on the silica.

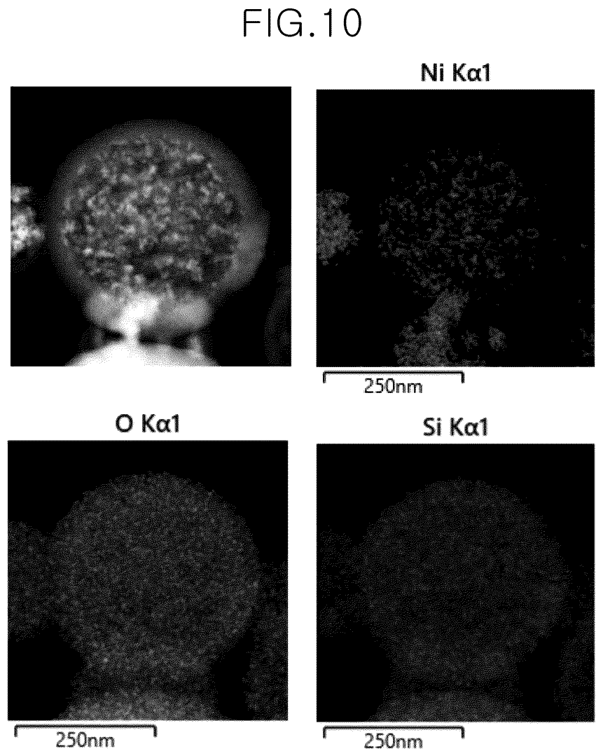

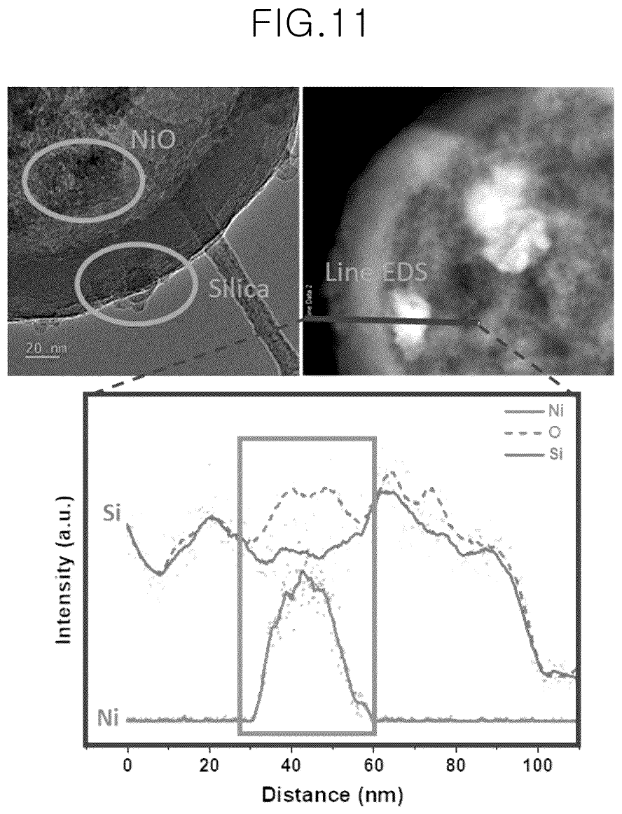

Also, energy dispersive X-ray spectroscopy (EDS) elemental analysis was performed on the catalysts manufactured according to Preparation Examples 8 to 14. The results are shown in FIGS. 10 and 11.

FIG. 10 shows energy dispersive X-ray spectroscopy (EDS) elemental analysis spectra of the catalysts manufactured according to Preparation Examples 8 to 14 of the present inventive concept, and FIG. 11 show an energy dispersive X-ray spectroscopy (EDS) elemental analysis spectrum of the catalyst manufactured according to Preparation Example 8 of the present inventive concept.

As shown in FIG. 11, it was confirmed that the manufactured catalysts were observed to have Ni, O, and Si uniformly distributed therein, and that nickel oxide (NiO), which is a metal, was supported on the silica support.

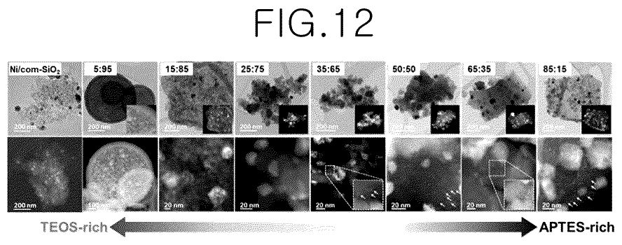

Also, the catalysts manufactured according to Preparation Examples 8 to 14 and the catalyst of Comparative Example 2 were measured using a high-resolution dual Cs-corrected transmission electron microscope (HR-STEM). The results are shown in FIG. 12.

FIG. 12 is a transmission electron microscope (TEM) image of the catalysts manufactured according to Preparation Examples 8 to 14 and the catalyst of Comparative Example 2.

As shown in FIG. 12, it can be seen that the catalysts manufactured according to the present inventive concept had high-temperature stability because the form of silica before impregnation was maintained even after nickel impregnation and high-temperature calcination on silica.

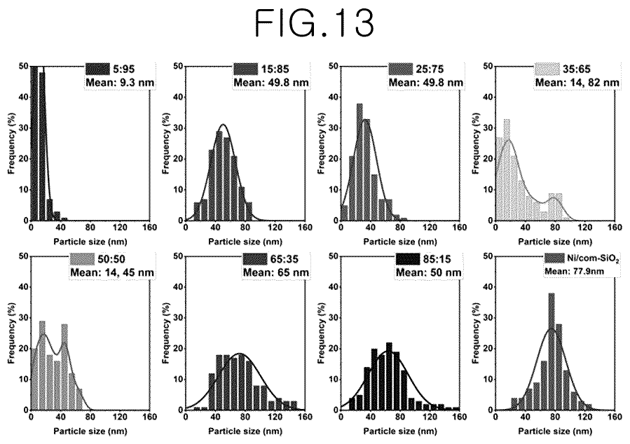

FIG. 13 shows the size distribution of nickel particles formed on the catalysts manufactured according to Preparation Examples 8 to 14 of the present inventive concept and a comparative example.

As shown in FIG. 13, it was confirmed that the nickel particles supported on the silica having a hollow spherical shell-type structure having an APTES/TEOS ratio of less than 0.1 had the smallest average particle size of 9.3 nm and a narrow particle size distribution range compared to other silica supports. These nickel particles were found to be disposed inside the shell, as shown in the energy dispersive X-ray spectroscopy (EDS) elemental analysis spectrum of FIG. 11.

Also, as shown in FIG. 13, the sizes of the nickel particles in both the TEOS-rich silica support (0.1<APTES/TEOS<0.5) and the APTES-rich silica support (APTES/TEOS>1) was generally greater than 40 nm. However, the basicity affected the size distribution of the nickel particles. Specifically, the TEOS-rich silica catalyst (0.1<APTES/TEOS<0.5) exhibited a narrower nickel particle size distribution than the APTES-rich silica catalyst (APTES/TEOS>1), and the nickel particle size distribution was expanded with an increasing concentration of APTES.

The presence of nano-sized nickel particles (approximately 1.8 nm) on the APTES-rich silica support (APTES/TEOS<0.1) indicates that nickel ions (Ni²⁺) may penetrate into the micropores because of the extremely negative charge on the surface of silica. However, when the APTES/TEOS ratio was greater than 1, the distribution of small Ni nanoparticles decreased rapidly. This trend was thought to be because the pore structure of the APTES-rich silica support significantly collapsed after nickel impregnation. From these results, it can be seen that the pore structure collapsed because the specific surface area of the silica support decreased rapidly from 342.9 m² g⁻¹ to 124.5 m² g⁻¹ after nickel impregnation, as shown in Table 4 below.

The TEOS-rich silica catalyst (0.1<APTES/TEOS<0.5) exhibited a structural change in which a part of the silica catalyst was converted from a bimodal pore configuration to a unimodal pore configuration after nickel impregnation.

Interestingly, Ni supported on the silica having an intermediate APTES/TEOS ratio (0.5≤APTES/TEOS≤1) was observed to include NiO particles having two sizes, that is, a smaller one (approximately 14 nm) in the mesopore structure and a larger one (greater than 40 nm) on the surface of silica.

To determine the pore characteristics of the catalysts manufactured according to the present inventive concept, experiments were also conducted as follows.

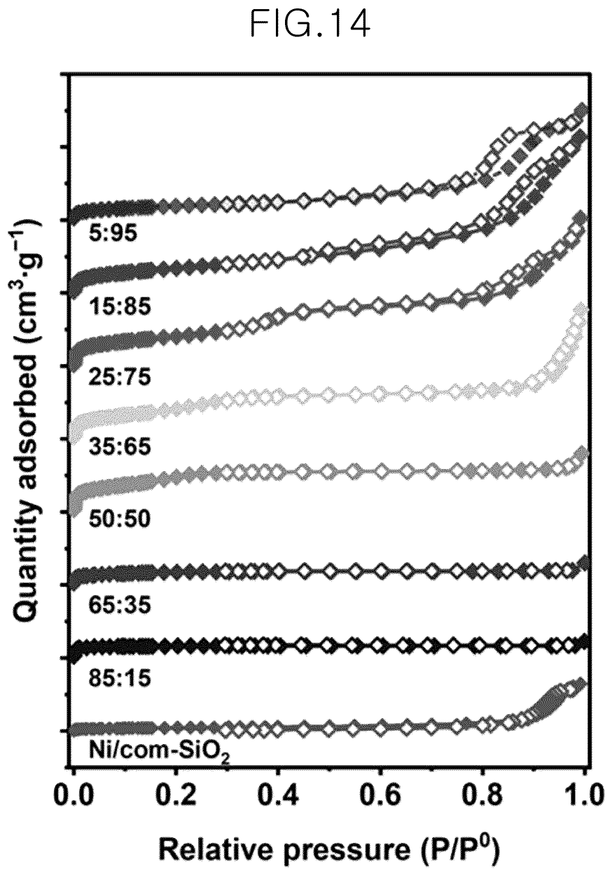

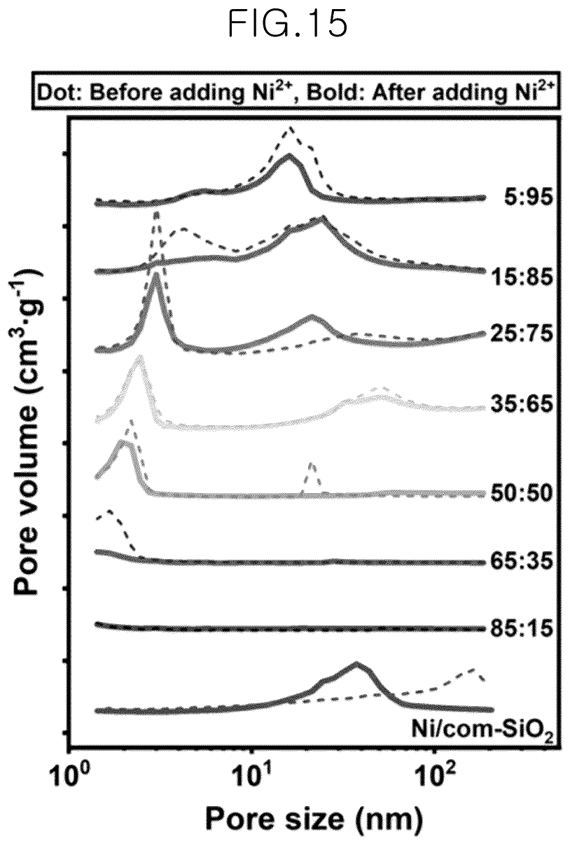

Specifically, the surface areas of the catalysts manufactured according to Preparation Examples 8 to 14 and the catalyst of Comparative Example 2 were measured by N₂ physical adsorption at −196° C. using a Micromeritics ASAP 2020 (MicrotacBEL Corp.) analyzer. The results are shown in FIG. 14. The specific surface areas and average pore diameters were calculated by the Brunauer-Emmett-Teller (BET) method, and the results are shown in Table 4 below, and the pore volumes were measured by the Barrett-Joyner-Halenda (BJH) method, and the results are shown in FIG. 15.

FIG. 14 shows N₂ adsorption curves for the catalysts manufactured according to Preparation Examples 8 to 14 of the present inventive concept and the catalyst of Comparative Example 2, and FIG. 15 is a BJH plot according to the amine concentration of the catalysts manufactured according to Preparation Examples 8 to 14 of the present inventive concept and the catalyst of Comparative Example 2.

TABLE 4

| | Specific surface | | Average pore | |
|---|---|---|---|---|
| | area [m²g⁻¹) | | diameter [nm] | |
| APTES:TEOS | Before Ni | After Ni | Before Ni | After Ni |
| molar ratio | impregna- | impregna- | impregna- | impregna- |
| (APTES/TEOS) | tion | tion | tion | tion |
| 5:95 (0.05) | 135.3 | 108.9 | 13.4 | 12.6 |
| 15:85 (0.17) | 288.8 | 249.6 | 10.3 | 10.6 |
| 25:75 (0.34) | 361.6 | 221.7 | 6.4 | 7.9 |
| 35:65 (0.54) | 391.4 | 286.2 | 5.7 | 7.2 |
| 50:50 (1.0) | 447.8 | 334.3 | 2.2 | 2.8 |
| 65:35 (1.87) | 453.3 | 121.6 | 1.9 | 2.6 |
| 85:15 (5.71) | 342.9 | 124.5 | 1.7 | 2 |
| Ni/com-SiO₂ | 18.1 | 141.6 | 17.4 | 28.1 |

As shown in FIG. 15, it was confirmed that the silica catalysts having a ratio of 0.5≤APTES/TEOS≤1 maintained a bimodal pore structure after nickel impregnation.

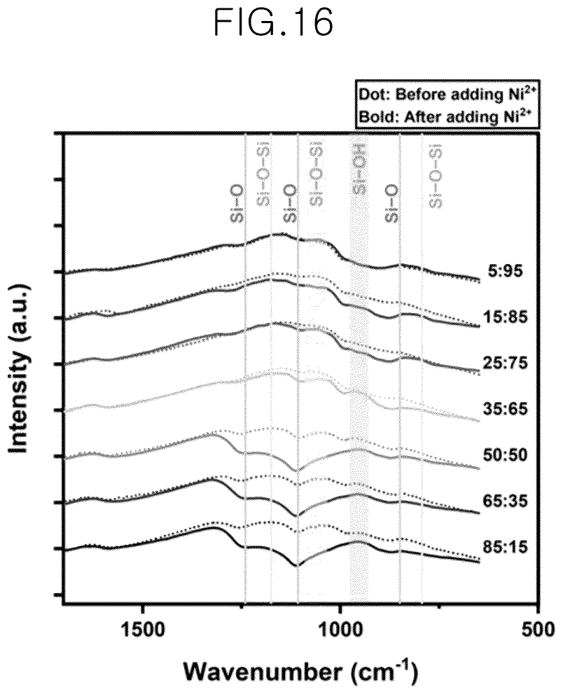

FIG. 16 shows surface IR profiles of the catalysts manufactured according to Preparation Examples 8 to 14 of the present inventive concept.

As shown in FIG. 16, the catalysts in which nickel particles are supported on silica having a core-shell structure with an APTES:TEOS ratio of 5:95 showed almost no change in the IR profile even after nickel impregnation, which suggests that the interaction between the nickel particles and the silica support is minimal. From these results, it can be seen that the nickel particles were encapsulated inside the silica support.

Also, it was confirmed that the catalysts having an APTES-rich silica support (APTES:TEOS=50:50, 65:35, 85:15) had bonds formed between nickel and silica as the peaks corresponding to the silica skeleton, i.e., Si—OH, Si—O, and Si—O—Si peaks, decreased when nickel was supported.

The strong interaction between these nickel cations and the APTES-rich silica may be explained by the negative zeta potential derived from the hydroxyl groups formed on the surface of silica. Specifically, the APTES-rich silica has increased amine cations on the surface as the APTES concentration increases before calcination, and these amine cations are converted to hydroxyl groups after calcination. Therefore, the APTES-rich silica has abundant hydroxyl groups formed on the surface after calcination, which may electrostatically interact with nickel cations, so that the nickel cations can be uniformly dispersed within the pores of silica.

The hydroxyl groups on the APTES-rich silica may contribute to the diversity of nickel species on silica below, reflecting the complex interactions between nickel incorporation and silica supports.

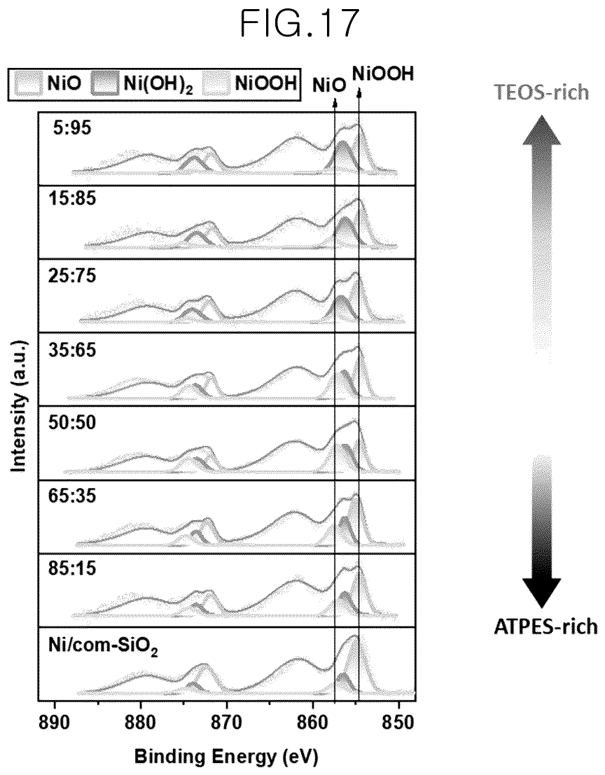

Next, X-ray photoelectron spectroscopy (XPS) for nickel was performed to identify the nickel species impregnated in the catalysts manufactured according to the present inventive concept. The results are shown in Table 5 and FIG. 17 below.

TABLE 5

| | Nickel | | | | | | |
|---|---|---|---|---|---|---|---|
| | oxyhydroxide | | Nickel hydroxide | | Nickel oxide | | |
| | (NiOOH) | | (Ni(OH)₂) | | (NiO) | | |
| APTES:TEOS | | Surface | | Surface | | Surface | NiOOH + |
| molar ratio | Binding | atomic | Binding | atomic | Binding | atomic | Ni(OH)₂/ |
| (APTES/ | energy | concentration | energy | concentration | energy | concentration | Ni phase |
| TEOS) | (ev) | (%) | (ev) | (%) | (ev) | (%) | (%) |
| 5:95 | 857.4 | 3 | 856.5 | 14 | 854.6 | 17 | 17 |
| (0.05) | | | | | | | |
| 15:85 | 857.7 | 4 | 856.3 | 11 | 854.4 | 21 | 15 |
| (0.17) | | | | | | | |
| 25:75 | 857.4 | 4 | 856.7 | 10 | 854.7 | 22 | 14 |
| (0.34) | | | | | | | |
| 35:65 | 857.2 | 13 | 856.4 | 12 | 854.5 | 16 | 25 |
| (0.54) | | | | | | | |
| 50:50 | 857.2 | 16 | 856.3 | 13 | 854.6 | 14 | 29 |
| (1.0) | | | | | | | |
| 65:35 | 857.5 | 9 | 856.3 | 10 | 855.0 | 18 | 19 |
| (1.87) | | | | | | | |
| 85:15 | 857.2 | 8 | 856.3 | 11 | 854.6 | 19 | 19 |
| (5.71) | | | | | | | |
| Ni/com- | 857.3 | 5 | 856.5 | 8 | 854.9 | 30 | 13 |
| SiO₂ | | | | | | | |

FIG. 17 is a Ni 2p XPS graph of the catalysts manufactured according to Preparation Examples 8 to 14 of the present inventive concept and the catalyst of Comparative Example 2.

As shown in FIG. 17, the XPS of the Ni 2p_{3/2} orbitals of the catalysts manufactured according to the present inventive concept was image-segmented into three peaks, where the peaks at approximately 855, 856, and 857 eV correspond to nickel oxide (NiO), nickel hydroxide (Ni(OH)₂), and nickel oxyhydroxide (NiOOH), respectively.

The ratio of NiOOH to Ni(OH)₂ increased with an increasing concentration of APTES, supporting that hydroxyl groups, which increase with the APTES concentration, induce and enhance the interaction between nickel and silica. In particular, when the APTES:TEOS molar ratios were 35:65 and 50:50, i.e., 0.5≤APTES/TEOS≤1, the sum of NiOOH and Ni(OH)₂ accounted for 25 to 29% of the total Ni phase. Thus, it was confirmed that the silica support had a higher ratio of hydroxyl groups compared to other molar ratios. Also, the silica catalysts having an APTES/TEOS ratio of more than 1 (65:35 and 85:15) showed a somewhat lower sum of NiOOH and Ni(OH)₂ due to a decrease in hydroxyl groups caused by the decreased BET surface area along with the collapse of the porous structure.

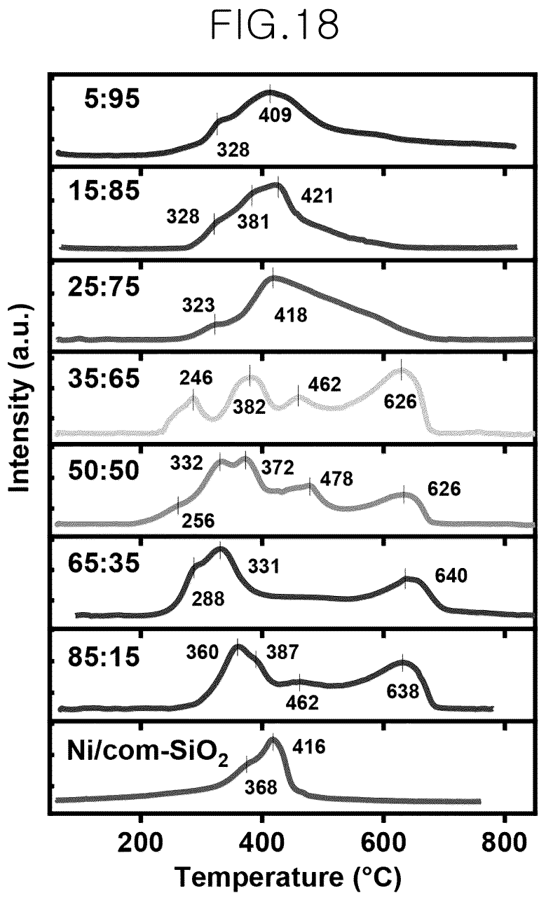

To identify and quantify nickel oxide species, H₂-temperature-programmed reduction analysis (H₂-TPR) was performed. Specifically, a sample was purged with Ar (50 cm³ min⁻¹) at 700° C. for an hour, cooled to 30° C. in a pure Ar flow, and then maintained for 30 minutes. Thereafter, 10% H₂/Ar (50 cm³ min⁻¹) was introduced into the sample, and the temperature was increased from 100° C. to 800° C. at a rate of 1° C./min. The results are shown in FIG. 18.

FIG. 18 is a graph showing the H₂-temperature-programmed reduction analysis of the catalysts manufactured according to Preparation Examples 8 to 14 of the present inventive concept and the catalyst of Comparative Example 2.

As shown in FIG. 18, the TEOS-rich silica catalysts (APTES:TEOS=5:95, 15:85, 25:75) showed large reduction peaks around 300 to 400° C. in relation to the NiO species, and as the APTES ratio increased, the Ni-supported silica catalysts having an APTES/TEOS ratio of more than 0.5 showed reduction peaks at 200 to 300° C., which is estimated to be the reduction of NiOOH (Ni³⁺) to hydroxyl Ni (Ni²⁺).

The catalysts having an APTES:TEOS ratio of 85:15 showed no reduction around 200° C. because the reduction of Ni³⁺ species was limited by the collapse of the porous structure of silica.

The catalysts having an APTES/TEOS of more than 0.5 showed additional peaks at a high temperature of 600° C. or higher. For samples that retained intact pore structures, these peaks were attributed to the reduction of nickel strongly bound to the silica structure. On the contrary, the catalysts exhibiting pore structure decomposition also showed peaks near 640° C., which is potentially estimated to be associated with the reduction of nickel impregnated in the non-porous silica.

Surface modification of silica by ATPES increased abundant hydroxyl groups to induce the high dispersion of an active metal having a small size (approximately 1.9 nm) and strong interaction with silica. Therefore, the basicity of silica may impart properties that are resistant to catalyst deactivation (sintering) in dry methane reforming. However, an excessively high concentration of APTES may cause the collapse of the pore structure, resulting in the formation of larger particles.

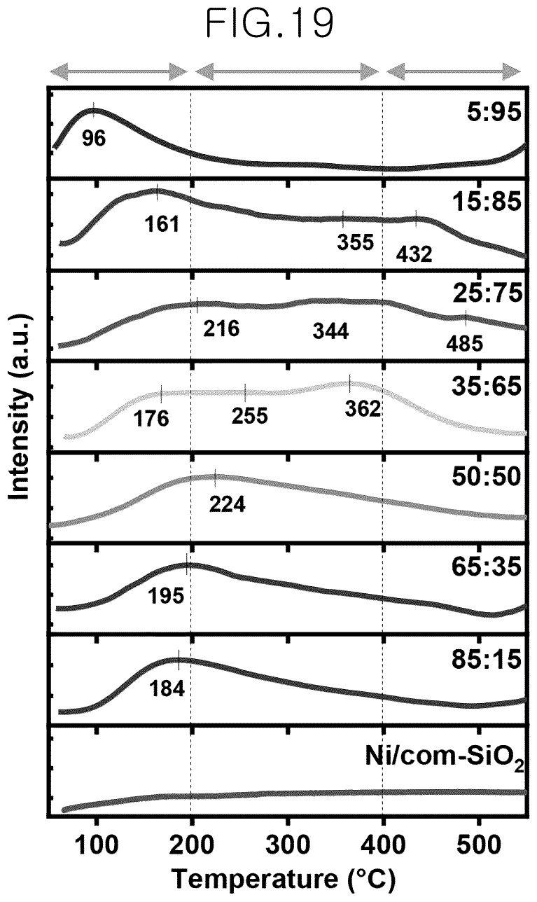

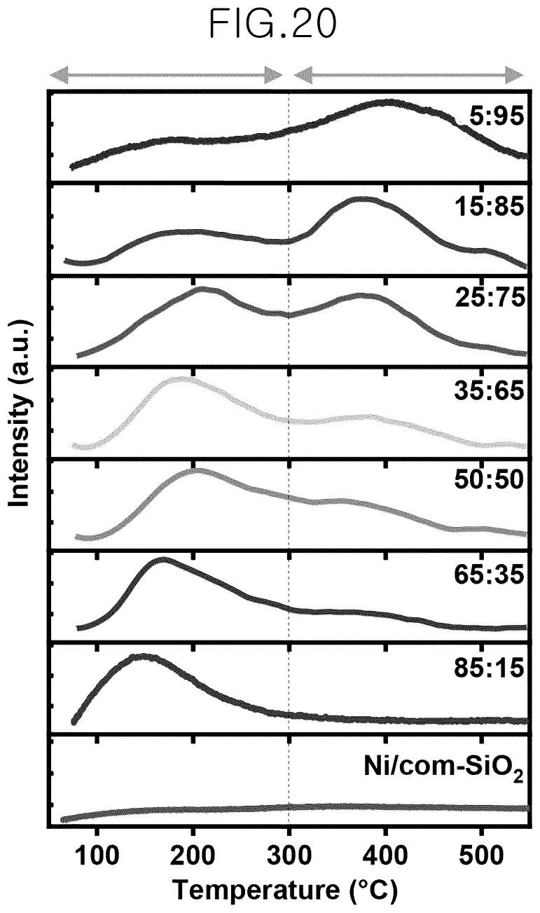

To confirm the acidity/basicity of the catalyst, CO₂-temperature-programmed desorption (CO₂-TPD) analysis and NH₃-temperature-programmed desorption (NH₃-TPD) analysis were also performed as follows. Specifically, the pores of the catalysts manufactured according to Preparation Examples 8 to 14 of the present inventive concept and the catalyst of Comparative Example 2 were pretreated at 500° C. for an hour in a He flow, and cooled from 500° C. to 100° C. in a pure He flow, and CO₂ or NH₃ was then adsorbed with 1% CO₂/He or 5% NH₃/He for an hour. Then, the catalyst was purged with a pure He flow. In this case, the physically adsorbed CO₂ or NH₃ was desorbed while increasing the temperature from 100° C. to 500° C. The results are shown in FIGS. 19 and 20.

FIG. 19 is a CO₂-temperature-programmed desorption (CO₂-TPD) analysis graph of the catalysts manufactured according to Preparation Examples 8 to 14 of the present inventive concept and the catalyst of Comparative Example 2, and FIG. 20 is an NH₃-temperature-programmed desorption (NH₃-TPD) analysis graph.

As shown in FIG. 19, in the basicity of the catalyst measured by CO₂-TPD, three different categories of basic sites were identified in different temperature ranges: 200° C.<T (Region I), 200° C.<T<400° C. (Region II), and T<400° C. (Region III). The TEOS-rich silica had three types of clearly distinguished basic sites.

However, as the concentration of APTES increased, the catalyst showed a prominent peak at intermediate temperature with an overlap between weakly basic and intermediate basic sites, which was due to the formation of dibasic carbonate on nickel hydroxide (NiOOH and Ni(OH)₂) by the hydroxyl groups (OH) on the surface of silica. Therefore, APTES treatment may potentially affect DRM performance by modifying the amount and distribution of basic sites on Ni-impregnated silica.

Also, as shown in FIG. 20, in the acidity of the catalyst measured by NH₃-TPD, all the samples showed broad desorption peaks at a temperature of less than 300° C. (Region I), indicating the presence of weakly acidic sites. The weakly acidic sites are related to the slight acidity of the silica support. Acidic sites are also observed around 300° C. in the silica catalysts with an intermediate ratio.

The TEOS-rich silica exhibited a large desorption peak at a temperature of more than 300° C. (Region II), indicating the presence of a significant number of intermediate acid sites. On the contrary, the APTES-rich silica catalysts exhibited relatively low levels of intermediate acidic sites, which are estimated to be due to the highly dispersed Ni that may neutralize the Bronsted acidic sites. Given that the catalytic acidity is often associated with carbon deposition, which leads to catalyst deactivation, TEOS-rich silica with high acidity is expected to be significantly affected by coking.

### Experimental Example 5: Measurement of Catalytic Activity of Nickel-Supported Silica Catalyst in Dry Methane Reforming Reaction

Catalytic activity was measured in a fixed bed reactor using a quartz tube. That is, the catalytic activity was measured after placing a quartz tube in the center of a reactor filled with a catalyst (20 to 30 mesh, 0.2 cc).

For steady-state tests, a feed gas stream consisting of 30 vol % of CH₄, 30 vol % of CO₂, and the balance of 40 vol % of Ar was introduced at a gas hourly space velocity (GHSV) of 250 Lg_{cat}⁻¹ h⁻¹. Prior to the activity test, the catalysts were pretreated with 10 vol. % of H₂/Ar at 700° C. (ramp: 20° C./min) for an hour, and then purged with Ar at the same temperature. Temperature-dependent activity tests were performed at 50° C. intervals from 500 to 850° C. (ramp: 5° C./min) while maintaining each temperature for 1.5 hours.

Stability tests were performed at a reaction temperature of 800° C. and a GHSV of 250 Lg_{cat}⁻¹ h⁻¹ using a standard sample composition. The gas flow rate was controlled by a mass flow controller (MFC, Brooks), and the composition of the outlet gas was analyzed online by gas chromatography (ChroZen GC system, YOUNG IN) equipped with a thermal conductivity detector (TCD) and a flame ionization detector (FID).

The molar balance conversion rate and H₂/CO ratio were calculated as follows.

$${CH}_{4} Conversion rate ( \% ) = \{ {( {CH}_{4} )}_{in} - {( {CH}_{4} )}_{out} \} / {( {CH}_{4} )}_{in} \times 100 \\ {CO}_{2} Conversion rate ( \% ) = \{ {( {CO}_{2} )}_{in} - {( {CO}_{2} )}_{out} \} / {( {CO}_{2} )}_{in} \times 100 \\ {H}_{2} / CO = [ {( {H}_{2} )}_{out} / 2 {( {CH}_{4} )}_{in} ] / [ {( CO )}_{out} / \{ {( {CH}_{4} )}_{in} + {( {CO}_{2} )}_{in} \} ]$$

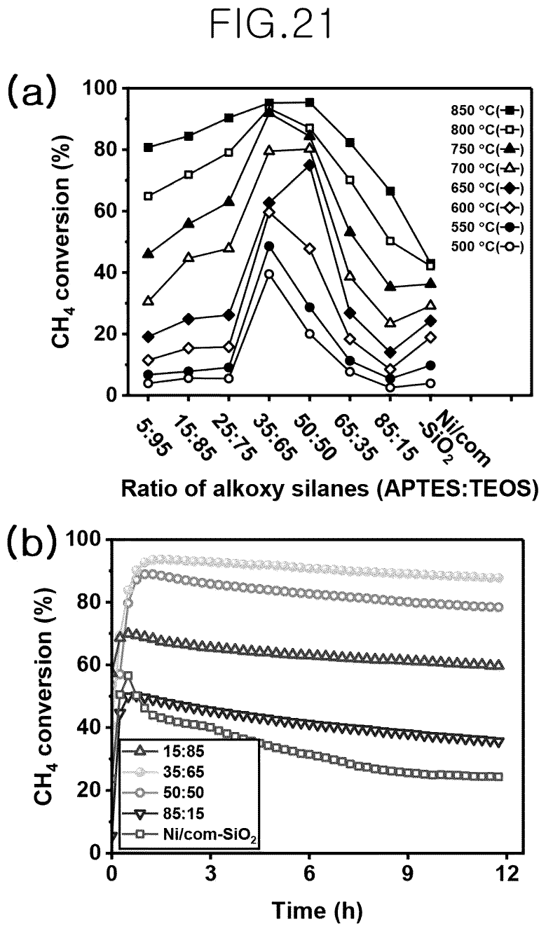

The measurement results are shown in FIGS. 21 to 24.

FIG. 21 is a graph showing the temperature-dependent activity of CH₄ conversion during dry reforming of methane (DRM) of the catalysts manufactured according to Preparation Examples 8 to 14 of the present inventive concept and the catalyst of Comparative Example 2.

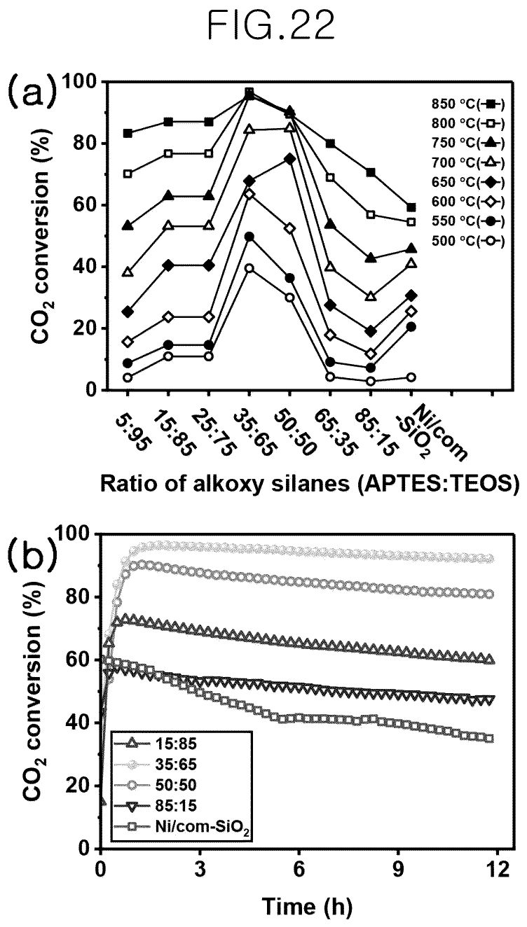

FIG. 22 is a graph showing the temperature-dependent activity of CO₂ conversion during dry reforming of methane (DRM) of the catalysts manufactured according to Preparation Examples 8 to 14 of the present inventive concept and the catalyst of Comparative Example 2.

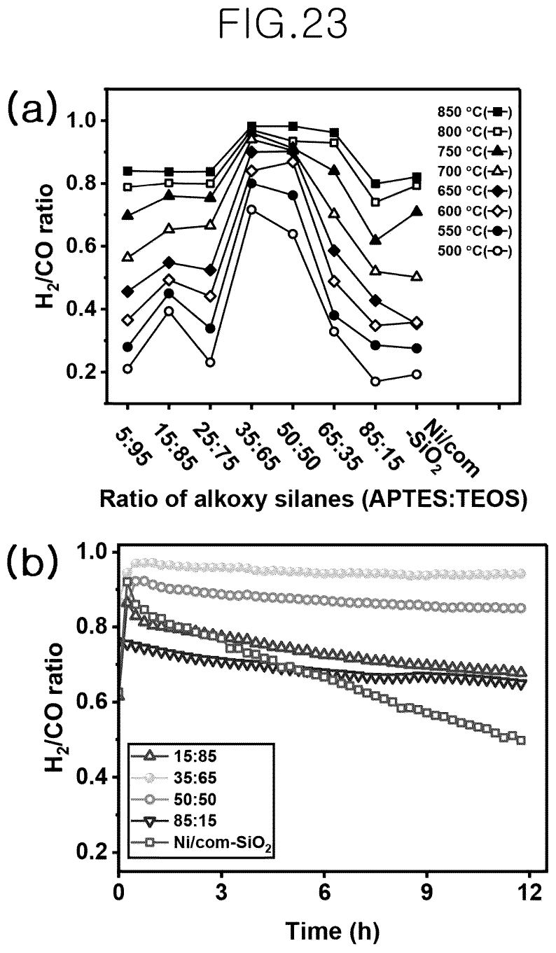

FIG. 23 is a graph showing the product ratios (H₂/CO) during dry reforming of methane (DRM) of the catalysts manufactured according to Preparation Examples 8 to 14 of the present inventive concept and the catalyst of Comparative Example 2.

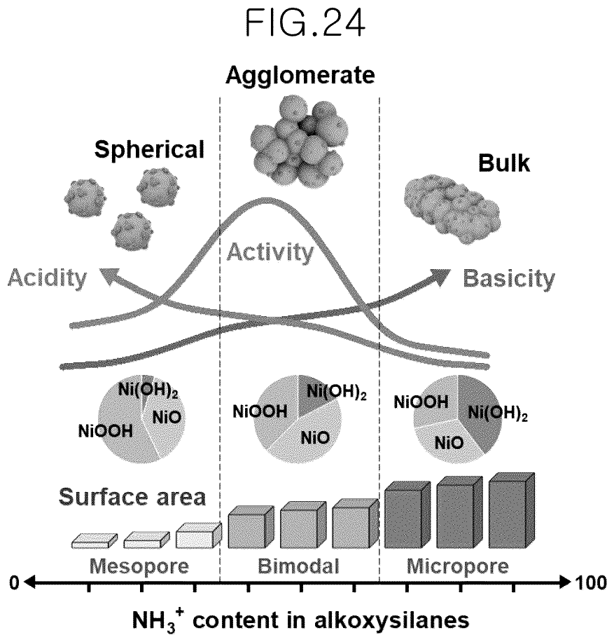

FIG. 24 is a graph showing the catalytic activity during dry reforming of methane (DRM) of the catalysts manufactured according to Preparation Examples 8 to 14 of the present inventive concept and the catalyst of Comparative Example 2.

As shown in FIGS. 21 to 24, the catalysts manufactured according to the present inventive concept exhibited higher performance in all areas of CH₄ conversion, CO₂ conversion, H₂/CO production ratio, and catalytic activity compared to commercially available Ni-com SiO₂ catalysts.

In particular, the catalysts having an intermediate APTES:TEOS ratio, i.e., 0.5≤APTES/TEOS≤1, exhibited superior DRM activities, which could be attributed to the unique pore structure and high-concentration of hydroxyl groups on the surface of silica. The bimodal pore structure maintained after nickel addition not only provided a large surface area but also ensured an improved reaction gas path. Meanwhile, the surface hydroxyl groups enabled well-dispersed Ni to strongly interact with silica and enhanced the basic sites to promote the dissociation/adsorption of CO₂ and alleviate carbon formation.

On the other hand, the APTES-rich silica catalysts did not show higher DRM activity than the TEOS-rich silica catalysts. This discrepancy may be attributed to the deterioration of the high surface area property of the APTES-rich silica because such silica has a damaged microporous structure after nickel incorporation, thereby limiting the access to the active sites.

Also, for the catalysts according to the present inventive concept, stability for the DRM reaction was also evaluated while performing a long-term test at 800° C. for 12 hours.

As a result, as shown in FIG. 22, it was confirmed that the catalysts manufactured according to the present inventive concept stably maintained a higher CO₂ conversion rate than the commercially available Ni-com SiO₂ catalyst for a long period of 12 hours.

In particular, it was confirmed that the catalysts having an intermediate APTES:TEOS ratio, i.e., 0.5≤APTES/TEOS≤1, not only had high catalytic activity with an initial CO₂ conversion rate of 94%, but also maintained the catalytic activity with a slightly decreased CO₂ conversion rate of 90% even after 12 hours. This resilience against deactivation may be attributed to the enhanced adsorption-dissociation of CO₂ at the weak/intermediate basic sites and the improved dispersion of nickel particles promoted by the hydroxyl group-rich surface of silica, as described above. Also, the stable bimodal pore structure is thought to have induced excellent DRM activity and stability by providing a fast diffusion path and ensuring a wide dispersion of the active metal.

Therefore, it was confirmed that the catalyst according to the present inventive concept had improved catalytic activity compared to catalysts in which nickel was supported on commercially available silica, that is, silica having mesoporous unimodal pores and containing no hydroxyl groups, by supporting an active metal on a silica support, which has a variety of controlled pore structures and silica shapes manufactured by controlling the ratio of two alkoxysilanes, TEOS and APTES, used as silica precursors, and has hydroxyl groups (—OH) formed on the surface thereof, and allowing the active metal to interact strongly with silica through the hydroxyl groups on the surface of silica in the form of various oxides.

In particular, when the ratio of TEOS and APTES is controlled to 0.5 or more and 1.0 or less, the silica support maintained a bimodal structure of first pores having an average pore diameter of 5 nm or less and second pores having an average pore diameter of 20 to 40 nm even when the catalysts were manufactured by supporting nickel as an active metal, and hydroxyl groups are formed on the surface of the support. As a result, nickel interacts strongly with silica through the hydroxyl groups on the surface of silica in the form of various nickel oxides, thereby enhancing catalytic activity, promoting dissociation/adsorption of CO₂, and alleviating carbon formation. Therefore, when nickel is used as a catalyst in a dry methane reforming reaction, it shows an initial CO₂ conversion rate of 94% and a CO₂ conversion rate of 90% or more even after 12 hours, indicating excellent catalytic activity. Therefore, nickel can be usefully used as a catalyst for a dry methane reforming reaction.

According to the present inventive concept, a porous silica support having a variety of controlled pore structures and silica shapes and having hydroxyl groups (—OH) formed on the surface thereof may be manufactured by controlling the mixing molar ratio of two alkoxysilanes (APTES and TEOS) used as silica precursors. In the catalyst in which an active metal is supported on the porous silica support, the active metal strongly interacts with silica through the hydroxyl groups, thereby enhancing catalytic activity, promoting dissociation/adsorption of CO₂, and alleviating carbon formation. Therefore, the catalytic activity is enhanced compared to a conventional catalyst in which an active metal is supported on silica having single mesopores and containing no hydroxyl groups in a dry methane reforming reaction.

In particular, when the ratio of TEOS and APTES is controlled to 0.5 or more and 1.0 or less, the silica support maintained a bimodal structure of first pores having an average pore diameter of 5 nm or less and second pores having an average pore diameter of 20 to 40 nm even when the catalysts were manufactured by supporting nickel as an active metal. Because this bimodal pore structure increases the surface area and pore volume compared to the unimodal pore structure, the access of reactants to active sites through larger mesopores can be facilitated, thereby improving the catalytic efficiency.

While the example embodiments of the present inventive concept and their advantages have been described in detail, it should be understood that various changes, substitutions and alterations may be made herein without departing from the scope of the inventive concept.

### BRIEF DESCRIPTION OF MAIN PARTS

10: porous silica support
20: active metal

What is claimed is:

1. A method of manufacturing a porous silica support, comprising:
reacting a reaction mixture consisting of water, a surfactant, aminopropyltriethoxysilane (APTES), and tetraethyl orthosilicate (TEOS) to form a silica gel (S10); and
calcining the silica gel to manufacture a porous silica support (S20),
wherein the pore structure and shape of the formed porous silica support are controlled by controlling the mixing molar ratio of APTES and TEOS (APTES/TEOS).

2. The method of claim 1, wherein a porous silica support in the form of a hollow spherical shell is manufactured by controlling the mixing molar ratio of APTES and TEOS (APTES/TEOS) to less than 0.1, wherein the porous silica support has an average pore diameter of 12 to 20 nm and a specific surface area of 130 to 140 m² g⁻¹ and has hydroxyl groups (—OH) formed on the surface thereof.

3. The method of claim 1, wherein a porous silica support, in which solid spherical silica particles are aggregated, is manufactured by controlling the mixing molar ratio of APTES and TEOS (APTES/TEOS) to 0.1 or more and 1.0 or less, wherein the porous silica support has a bimodal pore structure of first pores having an average pore diameter of 2 to 5 nm and second pores having an average pore diameter of 20 to 50 nm, wherein the pores are connected to each other to form a network structure, and has a specific surface area of 280 to 450 m² g⁻¹ and has hydroxyl groups (—OH) formed on the surface thereof.

4. The method of claim 1, wherein a bulky porous silica support, which has an average pore diameter of less than 2 nm and a specific surface area of 340 to 460 m² g⁻¹ and has hydroxyl groups (—OH) formed on the surface thereof, is manufactured by controlling the mixing molar ratio of APTES and TEOS (APTES/TEOS) to more than 1.0.

5. The method of claim 1, wherein the surfactant is selected from the group consisting of oleic acid, stearic acid, octanoic acid, decanoic acid, dodecanoic acid, tetradecanoic acid, hexadecanoic acid, octadecanoic acid, eicosanoic acid, docosanoic acid, cetrimonium bromide, dodecyltrimethylammonium bromide, and tetradecyltrimethylammonium bromide.

6. The method of claim 1, wherein the surfactant is included in an amount of 0.006 to 0.007 mol % with respect to water.

7. The method of claim 1, wherein the calcination is performed at 500 to 800° C. in air.

8. A catalyst for a dry methane reforming reaction, comprising:
the porous silica support manufactured in claim 1; and
an active metal supported on the porous silica support.

9. The catalyst of claim 8, wherein the porous silica support has a bimodal pore structure of first pores having an average pore diameter of 2 to 5 nm and second pores having an average pore diameter of 20 to 50 nm, and has hydroxyl groups (—OH) formed on the surface thereof.

10. The catalyst of claim 8, wherein the active metal is uniformly dispersed within the pores of the silica support through electrostatic interaction with the hydroxyl groups (—OH) on the surface of the silica support.

11. The catalyst of claim 8, wherein the active metal is nickel.

12. The catalyst of claim 11, wherein the nickel includes nickel oxide (NiO), nickel hydroxide (Ni(OH)₂), and nickel oxyhydroxide (NiOOH), and the nickel oxyhydroxide (NiOOH) has a surface atomic concentration (%) of 3 to 16%.

13. The catalyst of claim 11, wherein the nickel includes nickel oxide (NiO), nickel hydroxide (Ni(OH)₂), and nickel oxyhydroxide (NiOOH), and the sum of NiOOH and Ni(OH)₂ accounts for 13 to 29% of the total nickel (Ni) phase.

14. The catalyst of claim 11, wherein the nickel comprises NiO particles having a first size and disposed in the pores of the silica support and NiO particles having a second size and disposed on the surface of the silica support, wherein the first size is smaller than the second size.

15. A porous silica support in the form of a hollow spherical shell, which has an average pore diameter of 12 to 20 nm and a specific surface area of 130 to 140 m² g⁻¹ and has hydroxyl groups (—OH) formed on the surface thereof.

16. A porous silica support in which solid spherical silica particles are aggregated, wherein the porous silica support has a bimodal pore structure of first pores having an average pore diameter of 2 to 5 nm and second pores having an average pore diameter of 20 to 50 nm, wherein the pores are connected to each other to form a network structure, and has a specific surface area of 280 to 450 m² g⁻¹ and has hydroxyl groups (—OH) formed on the surface thereof.

17. A bulky porous silica support having an average pore diameter of less than 2 nm and a specific surface area of 340 to 460 m² g⁻¹, and having hydroxyl groups (—OH) formed on the surface thereof.
